(19) United States
(12) Patent Application Publication
(10) Pub. No.: US 2005/0212288 A1
(43) Pub. Date: Sep. 29, 2005

(54) Enhanced raintight compression fitting apparatus and techniques for its manufacture

(75) Inventor: Kenneth D. Stewart, La Verne, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Creftcon Industries, City of Industry, CA (US)

(21) Appl. No.: 11/078,053

(22) Filed: May 23, 2005

Related U.S. Application Data
(60) Provisional application No. 60/552,301, filed on Mar. 11, 2004.

(51) Int. Cl. F16L 33/00

(52) U.S. Cl. 285/249

(57) ABSTRACT

An improved compression conduit fitting intended to be attachable to threadless conduit. The conduit fitting includes a generally cylindrical body with a longitudinal internal bore extending there through. The body has an externally threaded conduit receiving end and an externally threaded conductor egressing end located opposite the receiving end. A coating of resilient sealing material is applied by brush or spray to the internal bore and conduit stop of the body during manufacture. Moreover, an internally threaded gland nut of annular shape is slideably positioned over the conduit to be securely attached to the body. Finally, a compression ring of annular shape is interposed between the gland nut and the body to compresses portions of the outer wall of the conduit against the sealing material coating adhering to the inner bore and inner conduit stop of the cylindrical body, thereby forming a liquid tight seal. Upon insertion of the conduit end, the resilient sealing material coating adhering to the inside of the bore contacts portions of the outer wall of the conduit and at the end of the conduit where it comes into contact with the inner conduit stop of the cylindrical body. It is mostly along the inner wall of the fitting and at the conduit stop where a liquid tight seal is achieved. Because the sealant material coating has some resilience, the resulting liquid tight seal is very accommodating to small imperfections occurring at the end of the conduit and the outer wall of the conduit near the conduit end when the conduit comes to rest against the conduit stop within the fitting body.

### CROSS REFERENCE TO RELATED APPLICATIONS

This application incorporates by reference in its entirety and claims priority to U.S. Provisional Application 60/552,301, filed Mar. 11, 2004, by inventor Kenneth D. Stewart.

### FIELD OF THE INVENTION

The present invention relates generally to compression fittings, and more particularly to enhanced raintight compression fittings for threadless conduit including but not limited to electrical metallic tubing (EMT) conduit.

### BACKGROUND OF THE INVENTION

Compression fittings are known in the art such as U.S. Pat. No. 4,194,768, which issued on Mar. 25, 1980 to Thomas J. Gretz entitled Liquid-Tight Connector and Published U.S. Patent Application US2002/0050718 to Roger D. Pyron, which was published on May 2, 2002.

EMT conduit is a metal conduit that encases electrical wiring. Typically the conduit is thin-walled and non-threaded. The EMT conduit is used to enclose electrical wires where the wiring might run along ceilings or walls such that the conduit is exposed. Where the EMT conduit carries wires to an electrical device, such as an electrical panel, there must be a rain-tight seal between the electrical device and the conduit. The fitting is typically attached to the end of the conduit, and the electrical wires extending through the conduit extend externally of the fitting for electrical termination. The fitting itself may be attached to various components such electrical panels or the like in order to provide mechanical and electrical termination of the conduit and the wire extending there through. In addition to the rain tight seal being formed, an electrical ground continuity between the EMT conduit and the EMT body also may be formed.

Recent changes in applicable standards, such as those promulgated by Underwriters Laboratories, have resulted in more stringent requirements for water resistance. Until now, conduit fittings of the prior art have been required to be “raintight”, that is, no appreciable water was allowed to pass through the fitting. The more stringent standards require the fitting to be essentially watertight, that is, to prevent substantially all water passage through the connection. It is, therefore, desirable to provide a conduit fitting which meets the more stringent “raintight” standards hereinafter called enhanced raintight standards.

The end user and manufacturer of electrical equipment are both faced with problems when conforming with the new “enhanced rain tight” standard. The end user needs a product that will satisfy the enhanced raintight standards despite imperfect cuts and slightly out-of-round conditions of conduit that may occur during installation in the field. The end user also needs a product of the simplest design with the fewest number of components. Manufacturers must provide a enhanced rain tight fitting which places an additional water barrier within their fittings beyond that provided by the compression ring widely used for many years to block off water penetration into the fitting. Presently, manufacturers have responded by placing gaskets or bushings within their fittings to provide a higher amount of liquid resistance. This approach requires the manufacturer to produce additional tooling, tie up additional work centers, increase production scheduling and inventory balancing, create additional part numbers, manage and store additional products, increase material handling, modify existing assembly components to accommodate the additional parts, and spend significant engineering and capital investment to orient and integrate the additional parts into the production process.

Because only a portion of electrical applications in the field require the enhanced rain tight performance of fittings, manufacturers may be compelled to make available an enhanced rain tight and a traditional “raintight” assembly to their customers as some end users will not accept the added cost of enhanced rain tight performance. This may necessitate the manufacturer to duplicate the original tooling so that an unmodified set of tools be available to run at a lesser cost per part for an assembly with the traditional “raintight” features.

Under enhanced rain tight conditions, imperfect conduit cuts can cause problems for the end user. During the installation process, standard sized conduit may need to be cut and/or bent to various lengths using various methods. These methods may include the use of a hacksaw or some other device that may not produce a clean and accurate cut. A lack of roundness of the conduit after cutting and a lack of squareness of the cut across the conduit can result in opportunities for leakage. End users would have reason to be concerned that a poorly cut conduit may not securely seal against the gasket provided by some enhanced rain tight fitting designs.

Because of the manual labor involved in installing conduit and fittings, end users find it valuable to work with products that are simple and effective in design. It is commonly held that time is saved when there are fewer parts to handle in an assembly. Prior inventions include removable or positionable members such as gaskets or bushings to provide resistance to liquid infiltration. These parts can fall out and need to be repositioned and possibly cleaned for correct installation. Repositioning can difficult if the extra part is asymmetrical requiring special orientation or it it's size is cumbersome being too small or too large for handling.

Typically, whenever a manufacturer has to create a new component, many steps are taken. These steps may include the following. Tooling for the new part must be designed and produced. Often a new work center will be purchased or at least an existing work center will need to be set up or modified in some way for a production run. Production control personnel must create a specific part number for the component itself and possibly the base material used so as to accurately schedule, count, store, and handle material for the new part effectively. Production management must adjust other product production schedules to make time for the new part. Engineers may modify tooling of existing components to allow the new enhanced rain tight component to correctly integrate within the assembly. In the event, the enhanced rain tight and traditional raintight assemblies are marketed as different products, a complete new set of tooling may need to be produced. If not, significant coordination between tools at the work center may become necessary to “changeover” from one assembly type to the other. In the case of a gasket or bushing, special orientation equipment or methods may be employed to integrate the new part at the site of manual or automatic assembly.

### SUMMARY OF THE INVENTION

It is an object of the present invention to provide a conduit fitting which meets the more stringent enhanced rain tight standards by providing a substantially watertight seal not only at the end of the conduit where it meets the conduit stop within the cylindrical body but also around and about the exterior wall of the conduit near it's end within the bore of the fitting body.

It is also the object of this invention to provide a resilient coating of waterproof material applied to either the fitting or to the conduit or both, so that when the conduit is inserted into the fitting, a seal is formed around the ending portion of the outer wall of inserted conduit, and particularly at the conduit stop.

Benefits of the Present Invention

The coating of resilient sealing material upon the walls and conduit stop of the fitting adapts to irregularities around the uneven space between the outer diameter of the conduit wall and the inner wall of the body. The sealing material may also be scraped from the sides of the inner wall of the body by parts of the conduit during the insertion of the conduit end toward the conduit stop. When this happens, the material will accumulate at or around the end of the conduit providing a better barrier to liquid as the conduit end comes in contact with the conduit stop located within the inner bore of the body.

The present invention provides the end user with a lower number of separate components to deal with. There is no additional loose member of the assembly to drop, or otherwise mishandle which could necessitate reorientation. In the instances where reorientation is necessary, an asymmetrical component could be incorrectly and dangerously installed. The simplicity of the present invention creates a market advantage as a saleable benefit.

The present invention will accommodate an imperfect conduit cut because the resilient characteristics of the sealant coating on the inner wall and conduit stop of the body allows it to fill and surround minor irregularities of the conduit at the end and on the wall of the conduit near the conduit end. This will improve the opportunity for water tight sealing while allowing for some end user error.

The present invention improves the ease of manufacture because it does not require additional separate components requiring separate hard tooling, machine scheduling, inventory management, parts counting, increased material handling between work centers, existing tooling modification of components of an existing assembly, possible design compromises or orientation for new unique or asymmetrical hard parts.

Improved Method of Manufacture

The present invention allows for simple and inexpensive modification of existing production lines so that inner bores of the assembly body can be coated, either by spray or brush method, and cured with heat and/or light as they lie oriented in queue for manual, semiautomated or automated assembly. Typically this is performed while the body rests in an index table, conveyor or rail system preparatory for assembly of the body with a gland nut and compression ring.

Changing production equipment to go from producing the present enhanced rain tight part to producing a traditionally “raintight” part and vice versa would only entail turning on or off the coating brush or sprayer operation and optronal heat or light curing operation. This “changeover” would be extremely quick and inexpensive giving the manufacturer more control over inventory investment by part type. This flexibility could increase service to the manufacturer's customer base, which has great commercial value.

The present invention provides a competitive advantage as it allows the manufacturer to produce an enhanced rain tight part without the cost of extensive tooling, part modification, expensive downtime, existing part modification, as well as production and inventory management disruption.

### BRIEF DESCRIPTION OF DRAWINGS

FIG. 1 is an exploded perspective view of a conduit and conduit fitting of the present invention.

FIG. 2 is a longitudinal section of the assembled conduit and fitting of the present invention.

FIG. 3 is a zoom view of the FIG. 2 displaying resilient sealing material location on the inner bore of the compression fitting as well as other items of the fitting assembly and conduit.

FIG. 4 is a separate view of the cylindrical body of the fitting with a coating of resilient sealing material adhering to the inner wall and conduit stop of the body.

### DETAILED DESCRIPTION OF THE PREFERRED EMBODIMENT

Referring now to the drawings and particularly to FIG. 1, there is shown an exploded view of conduit and the conduit fitting. The conduit fitting may be used to terminate an electrical conduit.

Conduit 10 is an elongate tubular member used to contain a plurality of electrical wires (not shown) therein. The conduit 10 is used to run wires over a longitudinal expanse so as to protect the wires within the conduit. Conduits of this type are well known in the art and may be formed of a variety of materials including rigid plastic and metal. Conduit 10 is an elongate tubular member having a first end through which the electrical wires would extend.

A preferred conduit fitting of the present invention includes a fitting body 11, a coating of resilient sealing material affixed to the inside bore of the fitting body 12, a compression ring 13 and a gland nut 14. The best mode contemplated at this time for providing the resilient sealing material is a room temperature curing silicone adhesive sealant such as the room temperature vulcanizing (RTV) series of silicones offered by GE Silicones, preferably RTV 118. Other suitable sealing materials are (1) a one component, fast cure, non-corrosive silicone adhesive sealant provided by GE Toshiba Silicones Co., Ltd under the product designation TSE397 (www.gesilicones.com) or (2) GE Silicone II Window and Door Sealant available from the same source.

Fitting body 11 is an elongate, generally cylindrical member typically formed of metal. However, the body may be comprised of materials that are non-metallic such as ceramic, plastic or composites that include such materials. The fitting body 11 also has a first externally threaded conduit receiving end and an opposed externally threaded conductor egressing end. A longitudinal bore extends therethrough bounding the fitting body 11. An external surface of fitting body may include a plurality of flat surfaces therearound that enable the fitting body to be gripped by an appropriate tool to facilitate tightening of the gland nut 14 onto body and the securement of body 11 to an external component such as an electrical panel.

Gland nut 14 is a generally annular member which is internally threaded for telescopic screw attachment to end of body 11. Gland nut 14 also includes a plurality of flat surfaces about the external surface thereof to facilitate securement of the gland nut onto the body.

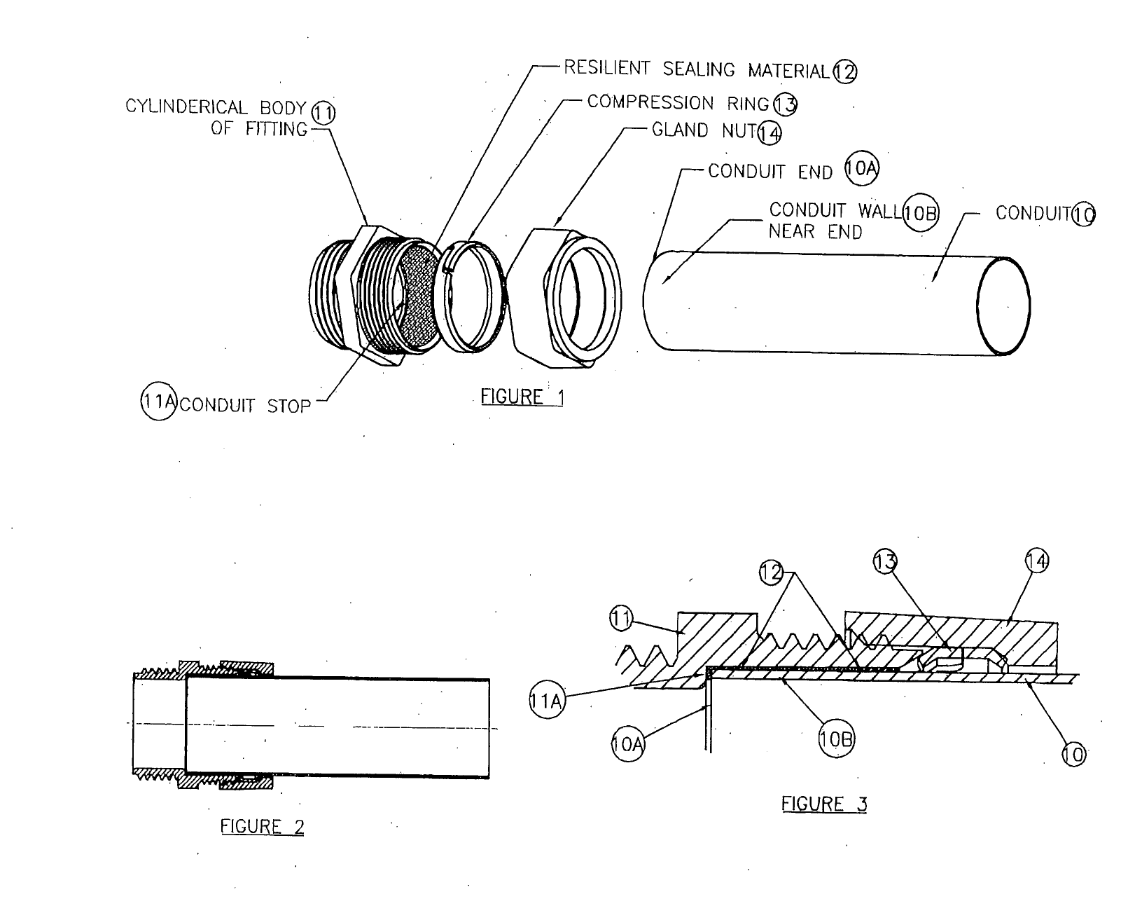

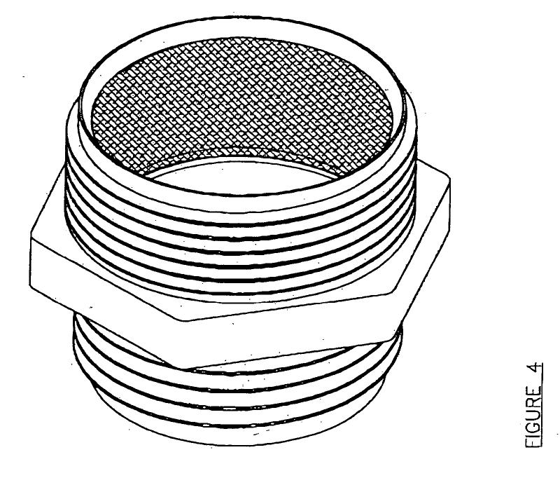

Interposed between gland nut and body is compression ring 13. Compression ring 13 is a split annular member typically formed of metal. In cross-section, as shown in FIG. 3, compression ring 13 has a flat surface and a pair of oppositely directed depending edges. Compression ring 13 is designed to fit about the exterior surface of conduit 10 where the split nature of ring 13 allows it to be tightened thereabout. Depending fingers enable the ring to tightly grip about the exterior surface of conduit.

Resilient sealing material 12 is coated upon the internal bore of body 11. Resilient sealing material 12 consists of a suitable, resilient silicon coating. In a preferred embodiment, resilient sealing material coating 12 is applied in sufficient thickness so as to engage the outer diameter and end of conduit 10. As shown in FIG. 2, this allows the end of conduit 10 to be positioned against the resilient material on the conduit stop 11a and on the inner walls of the fitting body 11, forming a seal.

Referring now more particularly to FIG. 3, the assembly of a fitting and its termination to the conduit 10 is described.

Gland nut 14 is slideably positioned over the conduit 10. The split compression ring 13 may be next positioned over the end of conduit 10a for captive receipt within gland nut 14. With the gland nut 14 and compression ring 13 positioned about conduit 10, and the resilient sealing material 12 positioned within body 11, end 10a of conduit 10 is inserted into the conduit receiving end of body 11. The conduit is inserted until the end 10a loosely abuts the conduit stop 11a of the body 11. The gland nut 14 may then be screw attached to the end of body 11 to secure the gland nut 14 to the body 11. Upon screw engagement of gland nut 14 onto body 11, the gland nut 14 will telescopically progress along the length of the conduit 10. As the compression ring 13 grasps the outer surface of the conduit 10, it will drive the conduit 10 forward within the body 11. The end of conduit 10a and the external conduit wall 10b adjoining the conduit end 10a compressively about against resilient sealing material which is a coating applied against a conduit stop 11a of the body 11, and also adhering along the inner bore of the fitting body 11 thereby compressing and reshaping the resilient sealing material 12 and forming a substantially watertight seal thereat around the end 10a and nearby wall 10b as it pushes against the conduit stop 11a and inner wall of the body 11.

Thus, in addition to the water resistant seal provided by the compression ring 13 about conduit 10, the present invention also provides a substantially watertight seal between portions of the outer wall of the conduit 10b and the inner wall of the body 11 as well as a substantially watertight seal between the conduit stop 11a located in the body 11 and the conduit end 10a.

While the invention has been described by the foregoing detailed description in relation to the preferred embodiments, it will be understood by those skilled in the art that various changes may be made without deviating from the spirit and scope of the invention.

1. A compression fitting, comprising
a. a substantially cylindrical body having an opening for receiving an end of a section of conduit and a conduit stop; and
b. a resilient sealing material coating at least a portion of the inside of the body from said opening at least up to said conduit stop.

2. The compression fitting of claim 1 having at least one threaded end.

3. The compression fitting of claim 1 further comprising a compression ring and a gland nut.

4. The compression fitting of claim 3 in which the resilient sealing material forms a enhanced rain tight seal when conduit is inserted into said body and held in place by said compression ring and gland nut.

5. The compression fitting of claim 1 in which said resilient sealing material is a room temperature curing silicone adhesive sealant.

6. A method of manufacturing an enhanced rain tight compression fitting, comprising the step of:
a. applying a resilient sealing material coating to the inside of a compression fitting body.

7. The method of claim 6 comprising the further step of curing the resilient sealing material using at least one of heat and light.

8. The method of claim 6 in which the resilient sealing material is applied as part of an assembly process that is at least semiautomated.

9. A method of forming an enhanced rain tight seal, comprising the step of:
a. applying a resilient sealing material coating to at least a portion of the inside of a compression fitting body from an opening for receiving a conduit at least up to a conduit stop.

10. The method of claim 9 further comprising the step of applying said resilient sealing material to at least a portion of the end of a section of conduit.

11. A method of converting a manufacturing process that produces rain tight compression fittings to one that produces enhanced rain tight compression fittings, comprising the step of providing selective activation of at least one of a coating operation and a curing operation.
